(19) United States
(12) Patent Application Publication
(10) Pub. No.: US 2003/0172570 A1
(43) Pub. Date: Sep. 18, 2003

(54) Card holder

(76) Inventor: Tsukasa Yoshida, Tokyo (JP)

Correspondence Address: SUGHRUE MION, PLLC, 2100 PENNSYLVANIA AVENUE, N.W., WASHINGTON, DC, 20037, US

(21) Appl. No.: 10/311,278

(22) PCT Filed: Aug. 6, 2001
(86) PCT No.: PCT/JP01/06748

(51) Int. Cl. G09F 3/20; A47G 1/06

(52) U.S. Cl. 40/658; 40/611.12; 40/793

(57) ABSTRACT

A basic piece having a thick potion has its end engaged with an outer covering piece so as to provide a card insertion opening formed on one side portion. A card pinching piece having elasticity is disposed in a space between the basic piece and the outer covering piece and attached to the outer covering piece such that one end of the card pinching piece abuts against the basic piece.

### TECHNICAL FIELD

The present invention relates to card holders used for pinching or holding cards such as memo papers, price lists, or the like on shelves in stores, on walls of houses, inside vehicles, or in other facilities.

### BACKGROUND ART

Conventionally, various types of such card holders have been developed, for example those as shown in FIG. 14 and FIG. 15. A card holder illustrated in FIG. 14 has a roller individually inserted in an outer covering member. A card holder illustrated in FIG. 15 includes a flat disc-shaped member, and the disc-shaped member has a side portion of its periphery opened, into which a card is inserted to be held. However, these conventional card holders are time consuming and expensive to manufacture, fail to smoothly attach and detach cards to be pinched, or limit a thickness of the card to be held. Additionally, most of the conventional card holders like that shown in FIG. 15 can only be used in limited places including the interior of a vehicle and hence lacks in general versatility.

The present invention has been accomplished in view of the aforesaid technical background, and it is an object of the present invention to provide a card holder that permits smooth attachment and detachment of any card without limiting a thickness of the card to be pinched, whose manufacturing costs are low, and which has ruggedness and enhanced versatility.

### DISCLOSURE OF THE INVENTION

According to the present invention, there is provided a card holder comprising a basic piece having a thick portion, an outer covering piece engaged with one end of the basic piece so as to provide a card insertion opening on one side portion of the basic piece, and a card pinching piece having elasticity and disposed in a space formed by the basic piece and the outer covering piece, the card pinching piece being attached to the outer covering piece such that one end of the card pinching piece abuts against the basic piece. The outer covering piece has hook-shaped basic-piece engaging portions protruding therefrom and which engage with inner and outer ends of the thick portion of the basic piece. Furthermore, the basic piece further comprises a base for engagement with a card, and the thick portion is formed by folding from one end of the base, so that the basic piece is formed to have a L-shaped cross-section. Also, the outer covering piece comprises a basic-piece attachment portion for engaging with the thick portion of the basic piece, an outer covering surface formed by folding from the basic-piece attachment portion, and an outer covering end having a half-round cross-section, so that the outer covering piece is formed to have a J-shaped cross-section, and the card pinching piece is attached to a back surface of the outer covering surface. Accordingly, the card pinching piece is attached inside the space, thus providing the card holder having a simple structure and ruggedness. The basic piece and the outer covering piece are assembled together after attaching the card pinching piece, thereby to facilitate manufacturing the card holder.

The card holder has a part of the base of the basic piece made of softer material than the others. This hopefully provides stronger pinching ability.

In this card holder, the card pinching piece is made of elastic material such as rubber, and comprises an attachment portion for attachment to the outer covering piece and formed to have a linear cross-section, a leg protruding from the attachment portion, and a pinching portion extending from one end of the leg, one end of the pinching portion serving as a basic-piece abutting portion for abutting against the basic piece and sloped in a direction of the card insertion opening. The pinching portion extends from the end of the leg in a trapezoid shape. Furthermore, the basic-piece abutting portion has its tip end formed in a stepped shape, and the tip end has arc-shaped pits and projections formed in a mutually staggered configuration. These features permit the card holder to have sufficient ruggedness to be applicable to a variety of thicknesses, and also allow smooth insertion, reliable pinching, and smooth drawing of the card.

The card pinching piece is composed of a plate spring, one end portion of which is the attachment portion for attachment to the outer covering piece, and a card pinching portion is formed by folding the plate spring with a slope from one end of the attachment portion, so that the card pinching piece is formed in a mountain-like shape. This makes the structure of the card holder simple, and allows the smooth pinching and drawing of the card.

One end of the card pinching portion is further folded to form a pinching protrusion. In more detail, the attachment portion has claw-like projections disposed on and extending from respective left and right sided ends of the plate spring in a width direction, and the one end of the card pinching portion is further folded to form the pinching protrusion. The attachment portion has its end or boundary folded back. This permits the smooth attachment and detachment of the card.

### BRIEF DESCRIPTION OF THE DRAWINGS

FIG. 1 is a sectional view showing an operating state of a card holder according to a first preferred embodiment of the present invention.

FIG. 2 is a sectional view of a basic piece according to the first preferred embodiment.

FIG. 3 is a sectional view of an outer covering piece according to the first preferred embodiment.

FIG. 4 is a sectional view of a card pinching piece according to the first preferred embodiment.

FIG. 5 is a perspective view of the card pinching piece according to the first preferred embodiment.

FIG. 6 is a partially perspective view of the card pinching piece according to the first preferred embodiment.

FIG. 7 is a perspective view showing a state of an assembly according to the first preferred embodiment.

FIG. 8 is a sectional view showing an operating state of a card holder according to a second preferred embodiment of the present invention.

FIG. 9(a) is a sectional view of a plate spring according to the second preferred embodiment, and FIG. 9(b) is a perspective view thereof.

FIG. 10 is a sectional view of a card holder according to a third preferred embodiment of the present invention.

FIG. 11 is a perspective view of a card pinching piece according to the third preferred embodiment.

FIG. 12 is a sectional view of a card holder according to a fourth preferred embodiment of the present invention.

FIG. 13 is a perspective view of a plate spring according to the fourth preferred embodiment.

FIG. 14 is a sectional view of a conventional card holder.

FIG. 15 is a perspective view of another conventional card holder.

FIG. 16 is a sectional view of a card holder according to a fifth preferred embodiment of the present invention.

### BEST MODE FOR CARRYING OUT THE INVENTION

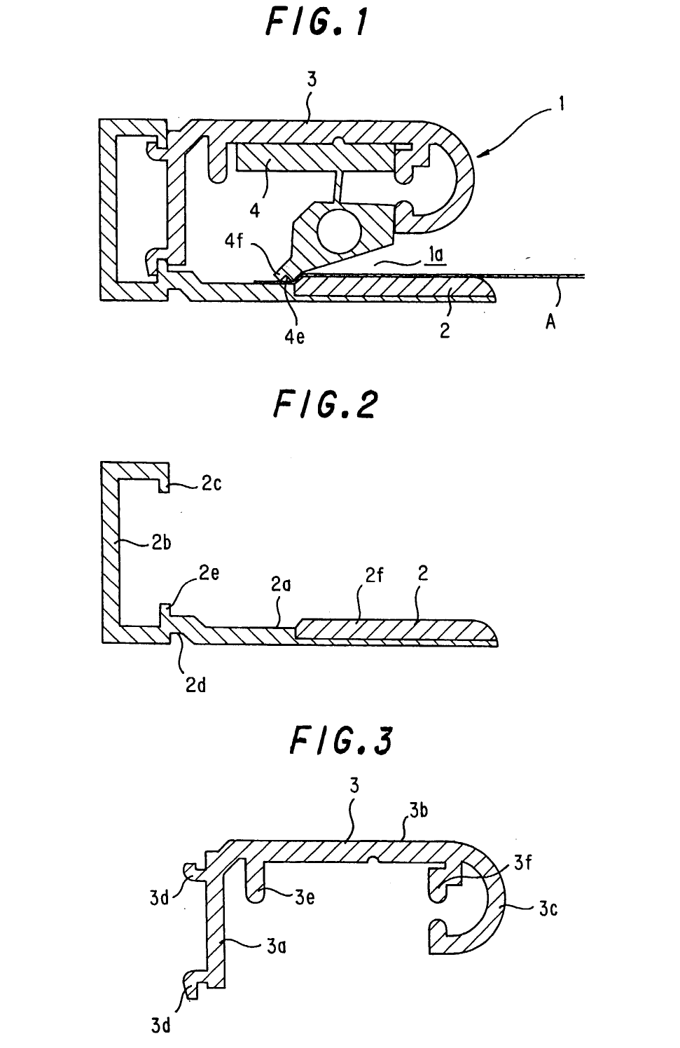

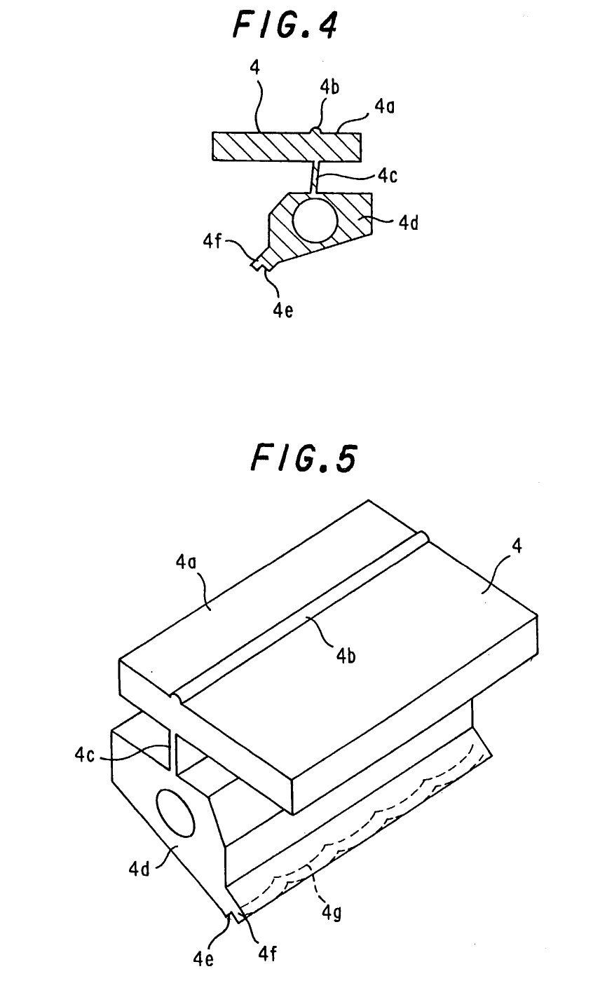

Hereinafter some preferred embodiments of the present invention will be described in detail with reference to the accompanying drawings. FIGS. 1 to 7 show sectional views of a first preferred embodiment. A card holder of the present invention, indicated at 1, includes a basic piece 2 made of hard synthetic resin or metal such as aluminum, an outer covering piece 3 integrally fitted into the basic piece 2 and made of hard synthetic resin or metal such as aluminum, and a pinching piece 4 disposed inside a space between the basic piece 2 and the outer covering piece 3 and made of elastic material. The card holder is formed as a long member that is to be cut to an appropriate length.

The basic piece 2, which is made of the hard synthetic resin, is formed to have a L-shaped cross-section. The basic piece 2 includes a base 2a having a linear cross-section. A thick portion 2b is formed by folding from one end or border of the base 2a at the right angle. One end portion of the basic piece is further folded, and then the tip end thereof is folded again in a hook-shape, to form an outer-covering-piece engaging portion 2c, which is the hook-shaped tip end. In the vicinity of the thick portion 2b is formed a recess 2d having a trapezoid-shaped cross-section. Another outer-covering-piece engaging portion 2e is provided facing inward with respect to the recess. A part from a tip end of the base 2a to a middle point thereof has its surface portion made of slightly softer synthetic resin 2f than the others, and this part is a little thicker than the others.

The outer covering piece 3, which is made of the hard synthetic resin, is formed to have a J-shaped cross-section. The outer covering piece 3 includes a basic-piece attachment portion 3a disposed so as to face the thick portion 2b of the basic piece 2. An outer covering surface 3b is formed by folding from the basic-piece attachment portion 3a at the right angle to have a linear cross-section. On a tip of the outer covering surface 3b portion is formed an outer covering tip end 3c having a half-round cross-section. On both inner and outer ends of the basic-piece attachment portion 3a are outwardly protruded hook-shaped basic-piece engaging portions 3d and 3d each of which has a L-shaped cross-section. On the back of the outer covering surface 3b, a small protrusion 3e for aligning the card pinching piece and having a linear cross-section is provided in the vicinity of the basic-piece attachment portion 3a. In contrast, near the tip of the outer covering surface 3b portion is provided another small protrusion 3f for aligning the card pinching piece and having a L-shaped cross-section. The outer covering end 3c has its head folded inward.

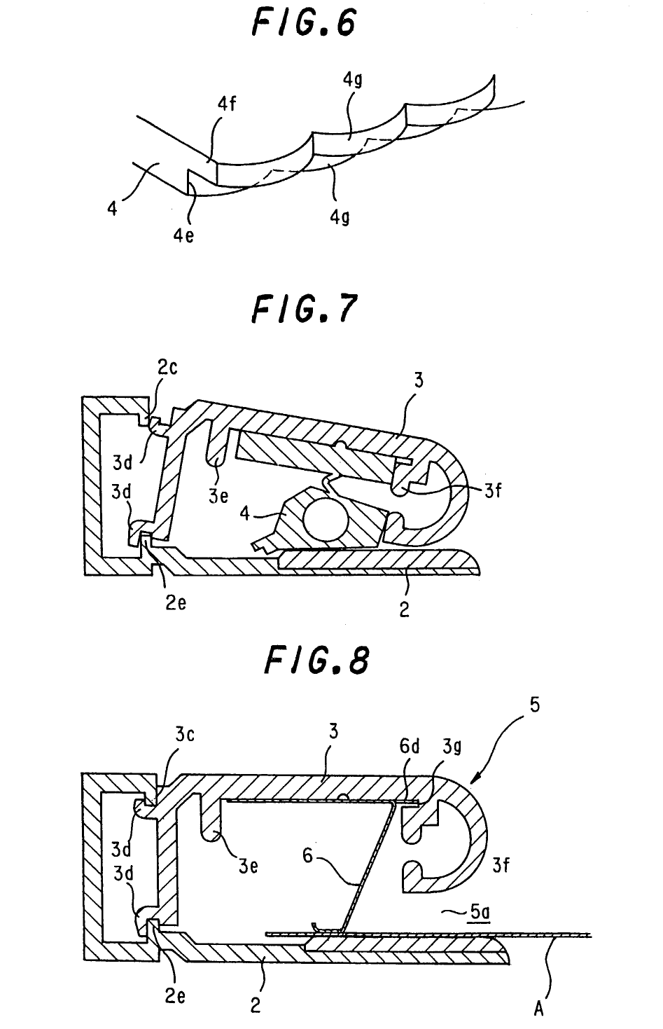

The card pinching piece 4 is made of elastic material such as chloroprene rubber, silicone rubber, or the like to be formed so as to have a prescribed length. This card pinching piece 4 is disposed and attached in a space formed by the basic piece 2 and the outer covering piece 3 with a predetermined space therefrom. An attachment portion 4a having a linear cross-section is provided with a small protrusion 4b formed at the middle point thereof. From a side opposite to the small protrusion 4b, is protruded a leg 4c which slopes slightly inward. And from the end of the leg 4c, a pinching portion 4d is extended. This pinching portion 4d is formed around a base of the leg 4c to have a substantially trapezoid-shaped cross-section. Further, the pinching portion 4d has its end sloped in a direction of the card insertion, and on a tip end or head of the pinching portion, cutouts are formed to provide double-stepped abutting portions 4e and 4f Preferably the tip end with these abutting portions 4e and 4f formed thereon, as shown in FIG. 6, has respective arc-shaped pits and projections 4g formed in a mutually staggered configuration.

Now the card holder 1 of the present invention having the above-mentioned parts will be manufactured as follows. First, the attachment portion 4a of the card pinching piece 4 is attached to the outer covering piece 3 between the small protrusions 3e and 3f provided on the back of the outer covering surface 3b of the outer covering piece 3 for aligning the pinching piece, with the small protrusion 4b fitted into a small recess formed on the outer covering piece 3. Subsequently as shown in FIG. 7, with the outer covering piece 3 inclined, the basic-piece engaging portion 3d provided on the inner side is engaged with the outer covering engaging portion 2e of the basic piece 2, and then the outer covering piece 3 is slightly rotated, so that the basic-piece engaging portion 3d provided on the outer side is engaged with the outer-covering-piece engaging portion 2c of the basic piece 2. At this time, the base 2a of the basic piece 2 is parallel to the outer covering surface 3b of the outer covering piece 3, and the pinching protrusions 4e and 4f of the card pinching piece is brought into abutment against the part of the basic piece 2. A space formed between the outer covering tip end 3c and the tip of the basic piece 2 serves as a card insertion opening 1a, into which a card A is inserted to be then pinched by the card pinching piece 4 and the basic piece 2, whereby the card is retained. Finally onto the back of the basic piece 2 is fixed a double-faced tape (not shown), thus facilitating attaching the card holder to an utensil and the like.

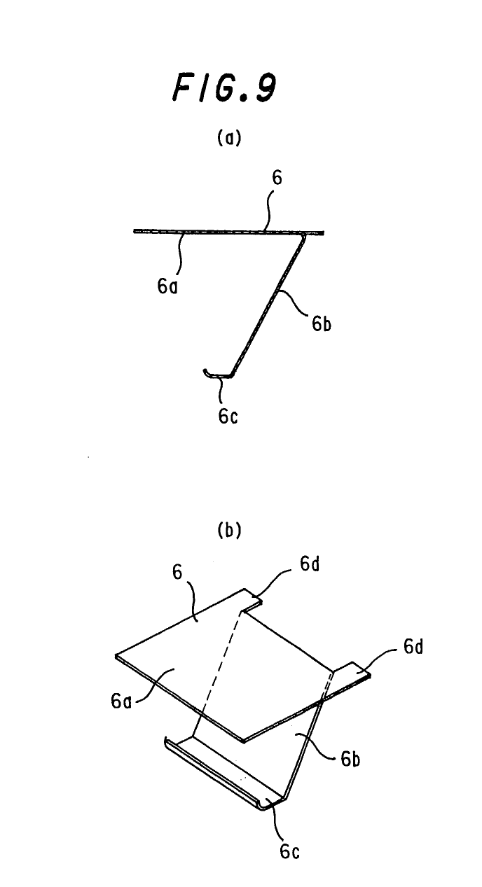

FIG. 8 and FIG. 9 show a second preferred embodiment. In this embodiment, the same basic piece 2 and the outer covering piece 3 as those of the first embodiment are utilized, but a plate spring 6 is substituted for the card pinching piece 4 of the first embodiment.

The plate spring 6 is made of elastic material including metal such as stainless steel, and is formed in a mountain-like shape as shown in FIG. 9. The plate spring 6 includes an attachment portion 6a having a linear cross-section. The plate spring 6 is folded with a slope from one end of the attachment portion 6a inward to form a card pinching portion 6b. Further one end of the card pinching portion 6b is folded in parallel with the attachment portion 6a to form a pinching protrusion 6c. The attachment portion 6a has claw-like projections 6d and 6d disposed on and extending from respective left and right sided ends thereof in a width direction.

The above-mentioned plate spring 6 has claw-like projections 6d inserted into a groove 3g that is disposed in the small protrusion 3f for aligning the outer covering piece 3, so that the plate spring is attached to the back surface of the outer covering piece 3. At this time, the tip of the plate spring 6, namely the card pinching protrusion 6c is brought into abutment against the basic piece 2. The card A is inserted into the card insertion opening 5a to be pinched by the basic piece 2 and the plate spring 6, whereby the card is retained.

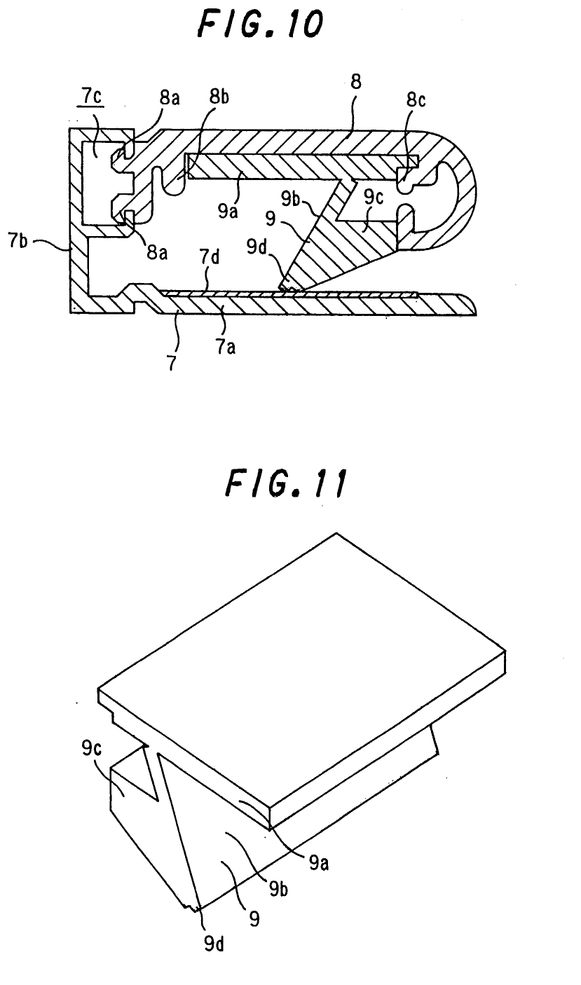

FIG. 10 and FIG. 11 show a third preferred embodiment. A basic piece 7 is made of hard synthetic resin and formed to have a substantially L-shaped cross-section. The basic piece 7 includes a base 7a having a linear cross-section, and one end of the base 7a is folded at the right angle to form a thick portion 7b. Further a tip of the thick portion 7b is folded at the right angle to form the L-shaped cross section. At a position below the tip by a prescribed interval is provided a L-shaped protruding piece opposite to the tip, to form an outer-piece engaging portion 7c having a C-shaped cross section between the tip and the protruding piece. Further, the base 7a has its inner surface portion composed of an elastic member 7d made of soft synthetic resin, rubber, or the like.

An outer covering piece 8 is made of hard synthetic resin and formed to have a substantially J-shaped cross section. One end of the outer covering piece is folded at the right angle, and from both ends of a folded piece are outwardly protruded hook-shaped basic-piece engaging portions 8a. A small protrusion 8b adjacent to the basic-piece engaging portion 8a is provided for aligning a pinching piece, and a small protrusion 8c having a L-shaped cross-section is provided located near the other end for aligning the pinching piece. Both protrusions 8b and 8c are protruded inward.

A card pinching piece 9 is made of elastic material such as chloroprene rubber, silicone rubber, or the like to be formed so as to have a prescribed length. This card pinching piece 9 is disposed and attached in a space formed by the basic piece 7 and the outer covering piece 8 with a predetermined space therefrom. The card pinching piece has a plate attachment portion 9a on the upper side, and a leg 9b protruding from the attachment portion 9a and sloped inward. And from the end of the leg 9a, a pinching portion 9c is extended outwardly in a trapezoid shape. An abutting end 9d of the pinching portion 9c against the basic piece is formed in a sawtooth-shape.

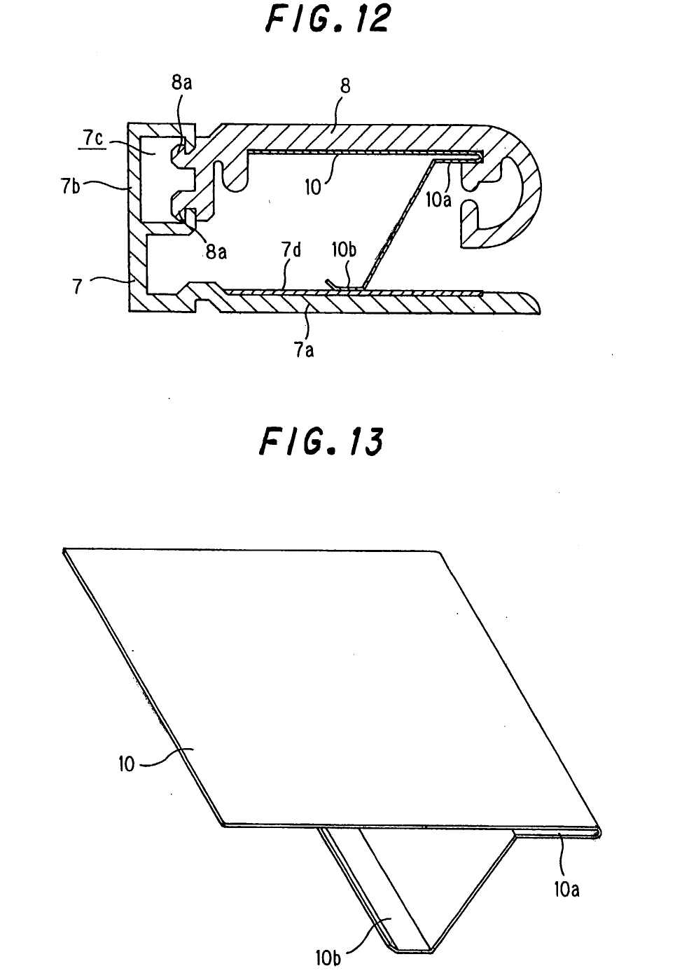

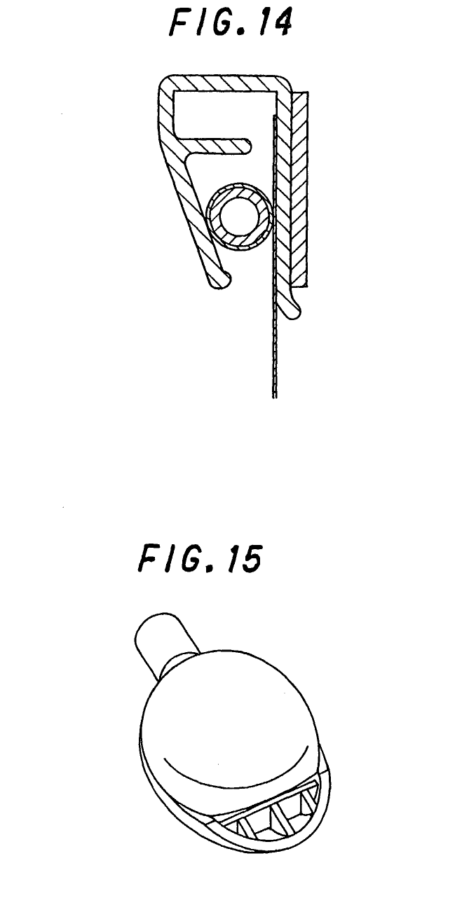

FIG. 12 and FIG. 13 show a fourth preferred embodiment. In this embodiment, the same basic piece 7 and the outer covering piece 8 as those of the third embodiment are utilized, but a plate spring 10 is substituted for the card pinching piece 9 of the third embodiment.

The plate spring 10 is made of elastic material made of metal such as stainless steel, and has a flat end folded into an attachment portion 10a. The plate spring is further folded with a slope inward to form a card pinching portion, a tip of which is folded in parallel with the attachment portion 10a to form a pinching protrusion 10b.

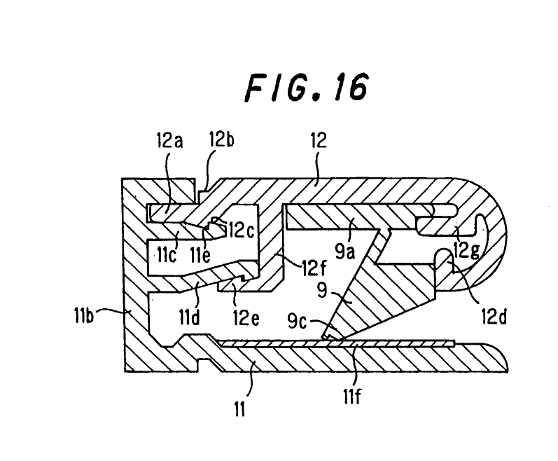

FIG. 16 shows a fifth preferred embodiment. A basic piece 11 is made of hard synthetic resin, and formed to have a L-shaped cross-section. The basic piece includes a flat base 11a in a linear shape. A basic end portion of the base 11a is folded at the right angle to form a thick portion 11b. A tip end of the thick portion is then folded at the right angle to form a L-shape. From this thick portion 11b, two protruding pieces 11c and 11d for engagement with the outer covering piece are protruded inward with a predetermined space therebetween. The protruding piece 11c is formed shortly in a cross-sectional linear manner. The outer-piece engaging portion has a reversed-V shaped engaging portion 11e which protrudes upward and which is formed by cutting out the upper side of the tip of the protruding piece. The protruding piece 11d for engagement with the outer covering piece is formed slightly long, and is folded upward from the middle point. The tip of the protruding piece 11d is extended in a hook-shaped manner. The base 11a has its inner surface composed of an elastic member 11f made of synthetic resin, rubber, or the like.

An outer covering piece 12 is made of hard synthetic resin, and formed to have a substantially J-shaped cross-section. The outer covering piece has a cross-sectionally linear engaging piece 12a formed on a basic end portion thereof. A small engaging protrusion 12b having a triangle-shaped cross-section is provided that protrudes outward, while an engagement cutout 12c having a triangle-shaped cross-section is provided that extends inward. The outer covering piece is sloped upward from there, and then is formed in a cross-sectionally flat and linear manner. The tip end of the outer covering piece is formed to have a half-round cross-section, whose tip end is then folded inward to form a card-pinching-piece retaining portion 12d. In the vicinity of the basic end portion, is protruded inward a L-shaped engaging piece 12f, a tip of which is extended in a cross-sectional triangle-shaped manner to form an engaging portion 12e. From the base having the tip in the half-round cross-section, is protruded inward a card-pinching-piece inserting portion 12g having a L-shaped cross-section.

Then, the folded tip of the basic end portion of the basic piece 11 is engaged with the small protrusion 12b for engagement of the outer covering piece 12. Subsequently the protruding pieces 11c and 11d for engagement are inserted between the basic end portion of the outer covering piece 12 and the engaging piece 11f, and their tips are engaged with the engagement cutout 12c and the engaging portion 12e, whereby the card holder is assembled. Between the L-shaped engaging piece 12f and card-pinching-piece inserting portion 12g, the card pinching piece 9 having the same construction as that of the third embodiment is attached to the outer covering piece via the attachment portion 9a with the pinching portion 9c abutting against the basic piece 11.

### INDUSTRIAL APPLICABILITY

The present invention relates to card holders widely used to pinch or hold cards such as memo paper, a price list, or the like on shelves in stores, on walls of houses, in event halls, inside vehicles, or in other facilities, and thus having improved versatility.

1. A card holder comprising a basic piece having a thick portion, an outer covering piece engaged with one end of said basic piece so as to provide a card insertion opening on one side of the basic piece, and a card pinching piece having elasticity and disposed in a space formed by the basic piece and the outer covering piece, said card pinching piece being attached to said outer covering piece such that one end of the card pinching piece abuts against said basic piece,
wherein said basic piece further comprises a base, a part of which is made of softer material than the others so as to engage with a card, said thick portion being formed by folding from one end of said base, so that said basic piece is formed to have a L-shaped cross-section,
wherein said outer covering piece comprises a basic-piece attachment portion for engaging with said thick portion of the basic piece, an outer covering surface formed by folding from said basic-piece attachment portion, and an outer covering tip end having a half-round cross-section, so that the outer covering piece is formed to have a J-shaped cross-section,
wherein said card pinching piece is attached to a back surface of the outer covering surface, and
wherein said card pinching piece is made of elastic material such as rubber, and comprises an attachment portion for attachment to the outer covering piece and formed to have a linear cross-section, a leg protruding from said attachment portion, and a pinching portion extending from one end of said leg in a trapezoid shape, one end of said pinching portion serving as a basic-piece abutting portion for abutting against the basic piece and sloped in a direction of the card insertion opening.

2. (Cancel)

3. (Cancel)

4. (Cancel)

5. (Cancel)

6. (Cancel)

7. The card holder according to claim 1, wherein said basic-piece abutting portion has its tip end formed in a stepped shape, and said tip end has arc-shaped pits and projections formed in a mutually staggered configuration.

8. The card holder according to claim 1, wherein said card pinching piece is composed of a plate spring, one end portion of which is the attachment portion for attachment to the outer covering piece, and a card pinching portion is formed by folding said plate spring with a slope from one end of the attachment portion, so that said card pinching piece is formed in a mountain-like shape,
wherein said attachment portion has claw-like projections disposed on and extending from respective left and right sided ends of the plate spring in a width direction, and
wherein the one end of said card pinching portion is further folded to form a pinching protrusion.

9. (Cancel)

10. (Cancel)

11. The card holder according to claim 1, wherein said card pinching piece is composed of a plate spring, and one end portion of which is the attachment portion for attachment to the outer covering piece, and
wherein said attachment portion has its one end folded back, thereby having the doubly folded portions.
